(19) United States
(12) Patent Application Publication
(10) Pub. No.: US 2018/0150886 A1
(43) Pub. Date: May 31, 2018

(54) CONTROLLING A CONTENT AUCTION WITH A THRESHOLD VALUE

(71) Applicant: Facebook, Inc., Menlo Park, CA (US)

(72) Inventors: Lei Wang, Santa Clara, CA (US); Tanmoy Chakraborty, San Mateo, CA (US)

(21) Appl. No.: 15/363,848

(22) Filed: Nov. 29, 2016

(51) Int. Cl. G06Q 30/02

(52) U.S. Cl. CPC G06Q 30/0275; G06Q 30/0254

(57) ABSTRACT

An online system receives requests from content providers to present content to a target user of the online system. A threshold value for the target user in an auction is determined based on historical auction data associated with the target user and only content items with maximum bid values greater than or equal to the threshold value can win an auction to present the content item to the target user. A winning candidate content item and a bid value for the winning content item are determined. The online system calculates a winning bid value based on a function of a total bid value of the second place candidate content item, an organic bid value of the winning content item and the threshold value determined for the target user. The content provider of the winning content item is charged the larger of the threshold value or the winning bid value.

### BACKGROUND

This disclosure relates generally to online content distribution, and particularly to determining which content to distribute to users using an auction, which selectively allows negative bids for sponsored content to be delivered to its target audience in an online system.

Content providers produce content and distribute it to users by themselves or through an online system. Online systems sometimes use an auction system to determine which of a set of competing candidate content items should be presented to users. The price a content provider pays the online system to present content to a user is based on a bid submitted by the content provider to the auction. Two properties of auctions which are commonly used to measure auction designs are incentive compatibility and individual rationality. An auction with the property of incentive compatibility is designed such that participants are incentivized to bid the true value they are willing to pay for presenting content to its target users. In an auction with the property of individual rationality, participants will not be charged more than their original bid by an auction system.

In some cases, the online system may alter the bid amount of a content provider to increase or decrease the chances that the content from that particular content provider is presented to a user. For example, the online system can reward a content provider whose content tends to receive positive feedback from users by inflating the content provider's bid value in the auction. Similarly, if a user often hides content from a content provider, the online system can deflate bid values by adding a negative value to the content provider's original bid.

There are certain aspects of these types of existing designs of auction systems that can be improved. For example, a content item from a content provider that has received negative feedback from its target users may cause other content items from the same content provider to have negative bid values, but negative bid values may not be permitted in the auction. In some cases, the online system may end up paying content providers to present their content to users, due to the artificial inflation of bid values, instead of receiving payment from the content providers for presenting their content to the target users.

### SUMMARY

Embodiments of the invention selectively allow negative bids for sponsored content to be delivered to its target audience in an online system. The online system receives multiple requests from content providers to present content items to a user. The content items and their corresponding total bid values are entered into an auction to determine which content item will be shown to the user. For each request from a content provider, the content provider provides a monetary value for a content item to be auctioned. The content item to be auctioned from a content provider is referred to as a “candidate content item.” The monetary value for a candidate content item from a content provider is referred to as a “content provider bid” or “provider bid.” For each candidate content item from a content provider, the online system assigns an organic bid. In one embodiment, the “organic bid” for a candidate content item is a monetary value determined by the online system based on a prediction of likelihood of positive feedback for the candidate content item and a prediction of likelihood of negative feedback for the candidate content item. The corresponding total bid value for the candidate content item is a sum of the provider's bid and the organic bid for the candidate content item. A negative bid occurs when a sum of the provider's bid and a negative organic bid is negative. The online system determines a threshold value or “price floor” that represents the minimum amount a content provider needs to pay to win an auction. If a content provider's bid is higher than the threshold value, the candidate content item may participate in an auction despite its negative total bid value. The threshold value is per user based (i.e., specific for each user), and is based on historical auction records of the cost to present competitive candidate content items to a user in the past, e.g., top 5% of auction data for the user from each auction participated in by the content providers in the past 7 days.

Any candidate content items with content provider bid values lower than the determined threshold value are filtered out and cannot win the auction. A winning candidate content item is selected from the remaining set of content items. The winner is chosen based on whichever content item has a largest total bid value after the online system has inflated or deflated the bid values. The winning content item is sent for presentation to the user.

The content provider associated with the winning candidate content item pays the larger between the total bid of the second place candidate minus the organic bid of the winning candidate content item and the threshold value determined for the winner content provider. By calculating a threshold value for each target user, the online system can ensure that the content providers will not owe a negative amount of money to the online system and that the user will receive some selected content even if the content may not have been selected under conventional auction systems.

### BRIEF DESCRIPTION OF THE DRAWINGS

FIG. 1 is a block diagram of a system environment in which an online system operates, in accordance with an embodiment.

FIG. 2 is a block diagram of the online system, in accordance with an embodiment.

FIG. 3A is a user interface of content that is presented to a user, in accordance with an embodiment.

FIG. 3B is a user interface illustrating content feedback widgets, in accordance with an embodiment.

FIG. 4 is a flowchart illustrating the process of performing an auction, in accordance with an embodiment.

FIG. 5 is a flowchart illustrating the process of determining a threshold bid value, in accordance with an embodiment.

FIG. 6 illustrates an example auction, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

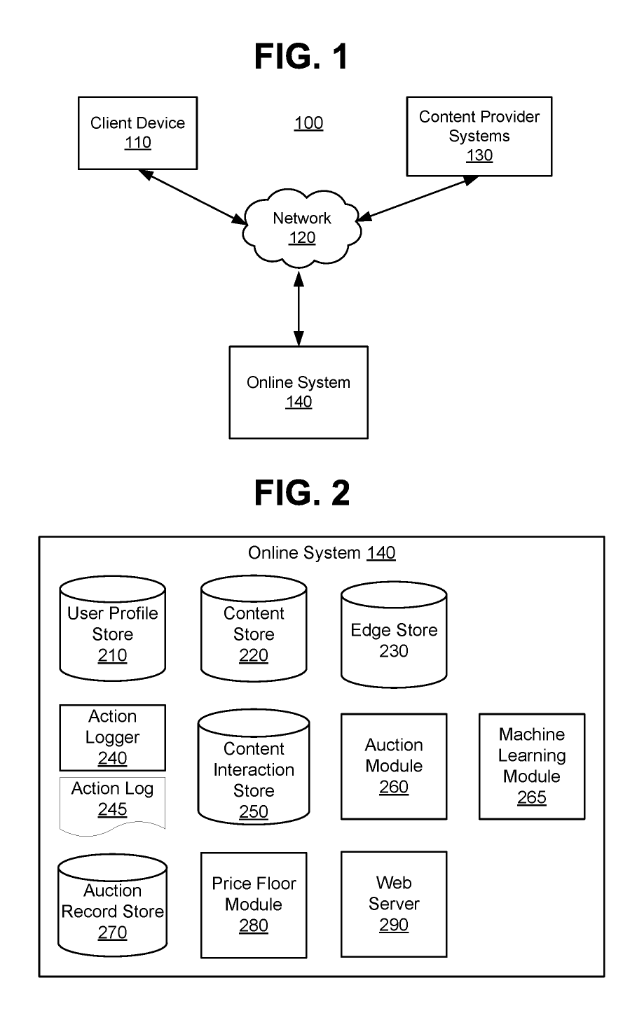

FIG. 1 is a high level block diagram of a system environment 100 for an online system 140. The system environment 100 shown by FIG. 1 comprises one or more client devices 110, a network 120, one or more content provider systems 130, and the online system 140. In alternative configurations, different and/or additional components may be included in the system environment 100. The embodiments described herein can be adapted to social networking systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more content provider systems 130 may be coupled to the network 120 for communicating with the online system 140, which is further described below in conjunction with FIG. 2. In one embodiment, a content provider system 130 provides content (e.g., sponsored content) for presentation via a client device 110 or other information (e.g., bid values for content items in an auction) to the online system 140. In other embodiments, the content provider system 130 is an application provider communicating information describing applications for execution by a client device 110 or communicating data to client devices 110 for use by an application executing on the client device. A third party website associated with the content provider system 130 may also communicate information to the online system 140, such as advertisements, content, or information about an application provided by the third party website.

FIG. 2 is an example block diagram of the online system 140. The online system 140 shown in FIG. 2 includes a user profile store 210, a content store 220, an action logger 240, an action log 245, an edge store 230, a content interaction store 250, an auction module 260, a machine learning module 265, an auction record store 270, a price floor module 280, and a web server 290. In other embodiments, the online system 140 may include additional, fewer, or different components for various applications. Conventional components such as network interfaces, security functions, load balancers, failover servers, management and network operations consoles, and the like are not shown so as to not obscure the details of the online system 140.

Each user of the online system 140 is associated with a user profile, which is stored in the user profile store 210. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 210 may also maintain references to actions by the corresponding user performed on content items in the content store 220 and stored in the action log 245.

While user profiles in the user profile store 210 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 220 stores objects that each represents various types of content. Examples of content represented by an object include a page post, a status update, a photograph, a video, a hyperlink, a shared content item, a gaming application achievement, a check-in event at a local business, an advertisement, a brand page, or any other type of content. Online system users may create objects stored by the content store 220, such as status updates, photos tagged by users to be associated with other objects in the online system, events, groups or applications. In some embodiments, objects are received from third-party applications or third-party applications separate from the online system 140. In one embodiment, objects in the content store 220 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140.

One or more content requests (“content requests”) are included in the content store. A content request includes content (e.g., sponsored content from a content provider) and a bid amount associated with the content (e.g., provider's bid). The content is text, image, audio, video, or any other suitable data presented to a user (e.g., a target user of the content). In various embodiments, the content also includes a landing page specifying a network address to which a user is directed when the content is accessed. The bid amount is used to determine an expected value, such as monetary compensation, provided by a content provider to the online system 140 if the content is presented to a user, if the content receives a user interaction (e.g., a click on an image of the content), or based on any other suitable condition. For example, the bid amount relates to a monetary amount that the online system 140 receives from the content provider if the content is displayed and the expected value is determined by multiplying the bid amount by a probability of the content being converted (e.g., a purchase of the content by the user). The bid amount may be further adjusted by multiplying a pacing multiplier, e.g., a value between 0 and 1, assigned by the online system 140 to help the content provider with bid amount allocation over a period of time (e.g., over 24 hours). In some cases, the amount paid to the online system 140 is not the bid amount for an ad that has won an auction, but is the next highest bid amount of the next highest ranked advertisement in the auction or is a bid amount otherwise tied to the next highest bid amount (e.g., slightly higher than the next highest bid).

Additionally, a content request may include one or more targeting criteria specified by the content provider. Targeting criteria included in a content request specify one or more characteristics of users eligible to be presented with content in the content request. For example, targeting criteria are a filter to apply to fields of a user profile, edges, and/or actions associated with a user to identify users having user profile information, edges or actions satisfying at least one of the targeting criteria. Hence, the targeting criteria allow a content provider to identify groups of users matching specific targeting criteria, simplifying subsequent distribution of content to groups of users.

In one embodiment, the targeting criteria may specify actions or types of connections between a user and another user or object of the online system 140. The targeting criteria may also specify interactions between a user and objects performed external to the online system 140, such as on a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a content provider system 130, or any other suitable action. Including actions in the targeting criteria allows advertisers to further refine users eligible to be presented with content from a content request. As another example, targeting criteria may identify users having a connection to another user or object or having a particular type of connection to another user or object.

The action logger 240 receives communications about user actions internal to and/or external to the online system 140, populating the action log 245 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 245.

The action log 245 may be used by the online system 140 to track user actions on the online system 140, as well as actions on third party systems 130 that communicate information to the online system 140. Users may interact with various objects on the online system 140, and information describing these interactions is stored in the action log 245. Examples of interactions with objects include: commenting on posts, sharing links, and checking-in to physical locations via a mobile device, accessing content items, and any other interactions. Additional examples of interactions with objects on the online system 140 that are included in the action log 245 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 245 may record a user's interactions with sponsored content on the online system 140 as well as with other applications operating on the online system 140. In some embodiments, data from the action log 245 is used to infer interests or preferences of a user, augmenting the interests included in the user's user profile and allowing a more complete understanding of user preferences.

The action log 245 may also store user actions taken on a third party system, such as an external website, and communicated to the online system 140. For example, an e-commerce website that primarily sells sporting equipment at bargain prices may recognize a user of an online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 245 may record information about actions users perform on a third party system, including webpage viewing histories, advertisements that were engaged, purchases made, and other patterns from shopping and buying.

In one embodiment, an edge store 230 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140. Users and objects within the online system 140 can be represented as nodes in a social graph that are connected by edges stored in the edge store 230.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 230 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 230, in one embodiment. Alternatively, each interaction between a user and a specific object is stored as a separate edge. In some embodiments, connections between users may be stored in the user profile store 210, or the user profile store 210 may access the edge store 230 to determine connections between users.

The content interaction store 250 stores information about interactions users have with content items. For example, a user can leave comments associated with content items, indicate a preference for a content item (i.e. “like” the content item), follow a user profile that posted the content item, click on a hyperlink associated with the content item, or indicate distaste of a content item using widgets. User interactions with content items can be positive or negative. In one embodiment, the online system 140 attributes positive or negative sentiment from users to certain content items based on user interactions. For example, the online system 140 associates negative user sentiment with a user request to hide the content item, and associates positive user sentiment with a user request to follow the user profile that posted the content item.

The auction record store 270 stores information about past auctions performed by each user or content provider. In one embodiment, historical auction data includes identification of content providers that participated in an auction, candidate content items, a date and time the auction occurred, results of the auction, bids of auction participants, and any other data related to the auction.

The machine learning module 265 applies machine learning techniques to generate a trained model that when applied to content items outputs indications of whether the content items have the associated property or properties, e.g., that when applied to content items outputs estimates of the likelihood of the content items being liked or disliked by target audiences. As part of the generation of the trained model, the machine learning module 265 forms a training set of content items by identifying a positive training set of content items that have been determined to have the property in question, and, in some embodiments, forms a negative training set of content items that lack the property in question. For example, the machine learning module 265 uses the user action data stored in the action log 245 and content interactions stored in the content interaction store 250 as the training set for training the first model for predicting the likelihood of content items being liked or receiving positive feedback and for training the second model for predicting the likelihood of content items being disliked or receiving negative feedback.

The machine learning module 265 extracts feature values from the content items of the training set, the features being variables deemed potentially relevant to whether or not the content items have the associated property or properties. Specifically, the feature values extracted by the machine learning module 265 include features associated with predefined events e.g., likes, dislikes, shares, comments/posts, hiding received content, conversion, types of conversions (e.g. purchasing or adding to shopping carts). An ordered list of the extracted features for positive feedbacks is herein referred to as the feature vector for the positive feedback used in calculating an organic bid for a content item for a target user. Similarly, an ordered list of the extracted features for negative feedback is herein referred to as the feature vector for the negative feedback used in calculating the organic bid for the content item for a target user.

The machine learning module 265 uses supervised machine learning to train the first model and the second model, with the feature vectors of the positive training set and the negative training set serving as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. The trained model, when applied to the feature vector extracted from user a content item, outputs an estimation of a likelihood that the content item receives a positive feedback or a negative feedback. In other embodiments, the machine learning module 265 may train one or more additional models to predict conversation rate associated with content items provided by content providers. The trained model can be used to assist the auction module 260 in selecting suitable content items for their target audiences.

The price floor module 280 determines a minimum value for a target user that a content provider needs to bid to win an auction. A minimum value (also referred to as a “threshold value” or a “price floor”) is determined for each auction associated with each target user. Each threshold value is specific to the target user who will receive the content from the content provider 130 that submits a winning bid. The price floor module 280 calculates the threshold value for a user using data from records of previous auctions for the user, stored in the auction record store 270. The process of determining a threshold value is further detailed in the description of FIG. 5.

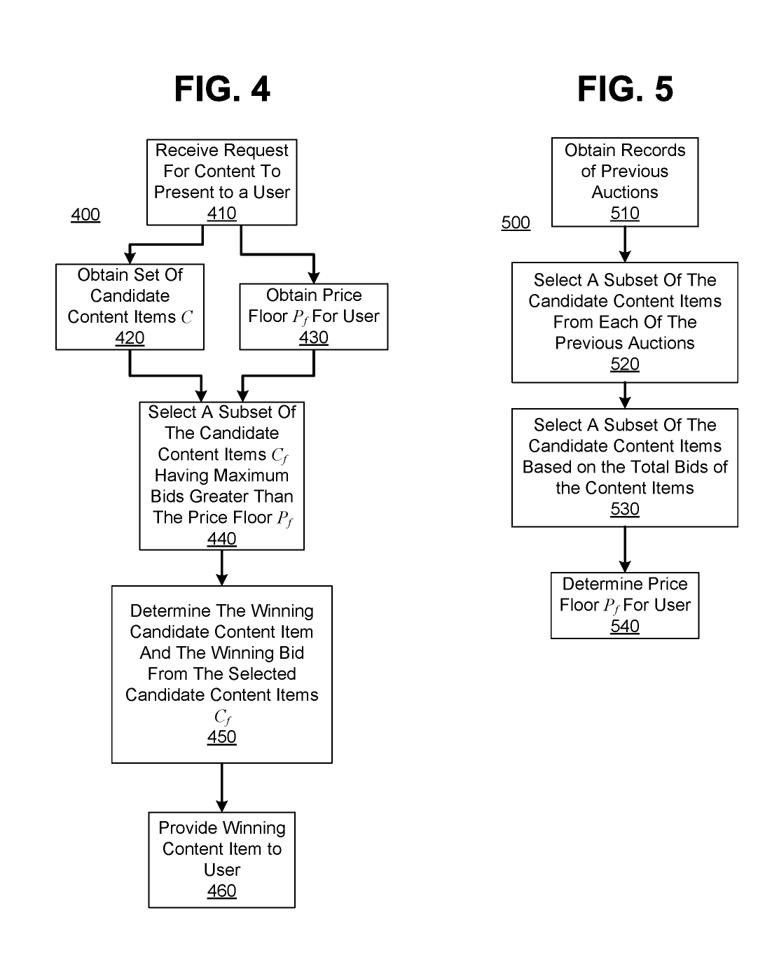

The auction module 260 runs an auction to determine which of a set of candidate content items will be presented to a user. In one embodiment, the auction module 260 determines a total bid for a candidate content item based on a content provider bid provided by a corresponding content provider, an organic bid calculated by the online system 140, and the threshold value determined by the price floor module 280. In some cases, the content provider bid is actually determined by the online system instead of the content provider, but the content provider sets the overall budget per day or per ad campaign so that the online system can select the best bids that allow for pacing of the budget use throughout the ad campaign or throughout some other time period. The auction module 260 determines which candidate content items have high enough bids to participate in the auction. The auction module 260 compares the total bids of all candidate content items participating in the auction and selects a winning candidate content item for presentation to the user. Additional details about the auction process are provided as a description of FIG. 4.

The organic bid associated with a content item is a combination of a positive and negative bid value that are added to the content provider bid of the content item by the online system 140 when calculating the total bid value for the content item. The organic bid for a content item is based on the feedback received from users by the online system 140 in response to content items presented to the users. In one embodiment, the organic bid, Oₙ, is the difference between an estimated like bid, Lₙ, and an estimated negative feedback bid, Nₙ, which can be expressed as Oₙ=Lₙ−Nₙ. A like bid for a content item is a value, determined by the online system 140, which is based on a probability that a user will like the content item. A negative feedback bid for the content item is a value, determined by the online system 140, which is based on a probability that a user will give negative feedback for the content item. For example, the online system 140 may use a machine learning model that analyzes a user's historical rate of hiding content items and predicts the probability that the user will provide negative feedback to future content to determine a negative feedback bid. If a negative feedback bid is larger than a like bid, the organic bid will be a negative value. A negative organic bid for a content item decreases the chance that a content provider providing the content item will win an auction because the value of the total bid of the content item is reduced by an amount of the negative organic bid.

The web server 290 links the online system 140 via the network 120 to the one or more client devices 110, as well as to the one or more content provider systems 130. The web server 290 serves web pages, as well as other web-related content, such as JAVA®, FLASH®, XML and so forth. The web server 290 may receive and route messages between the online system 140 and the client device 110, for example, instant messages, queued messages (e.g., email), text messages, short message service (SMS) messages, or messages sent using any other suitable messaging technique. A user may send a request to the web server 290 to upload information (e.g., images or videos) that is stored in the content store 220. Additionally, the web server 290 may provide application programming interface (API) functionality to send data directly to native client device operating systems, such as IOS®, ANDROID™, WEBOS® or RIM®.

### User Interface for Presenting Content Items

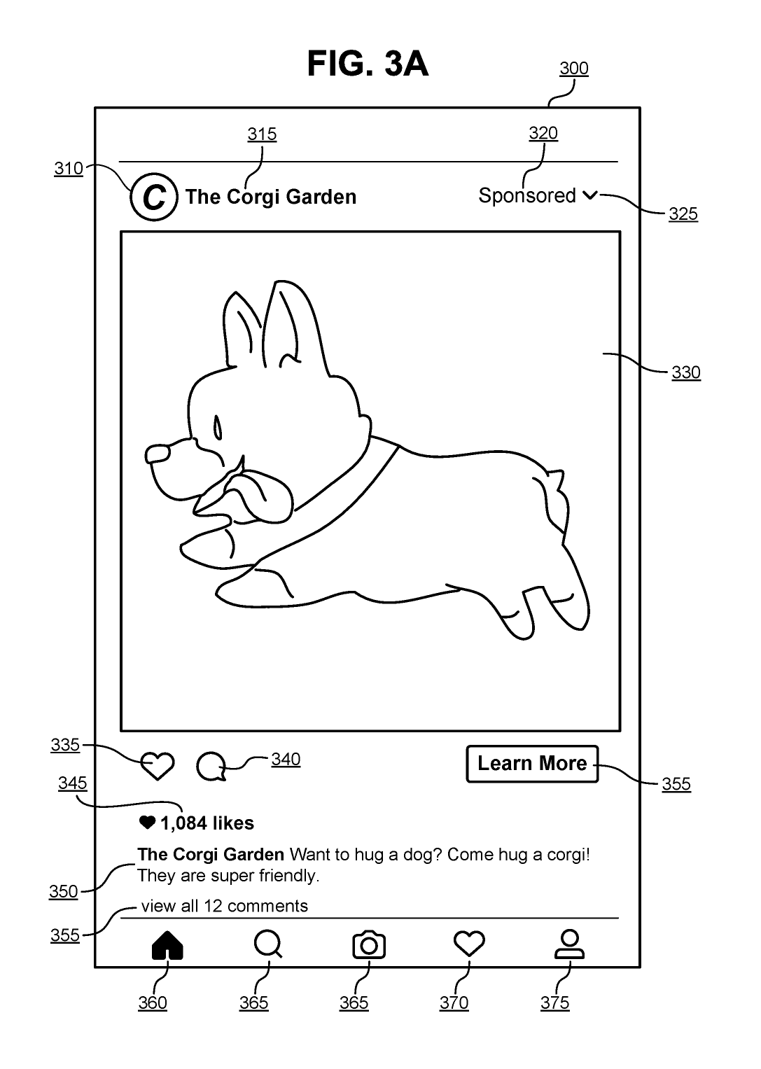

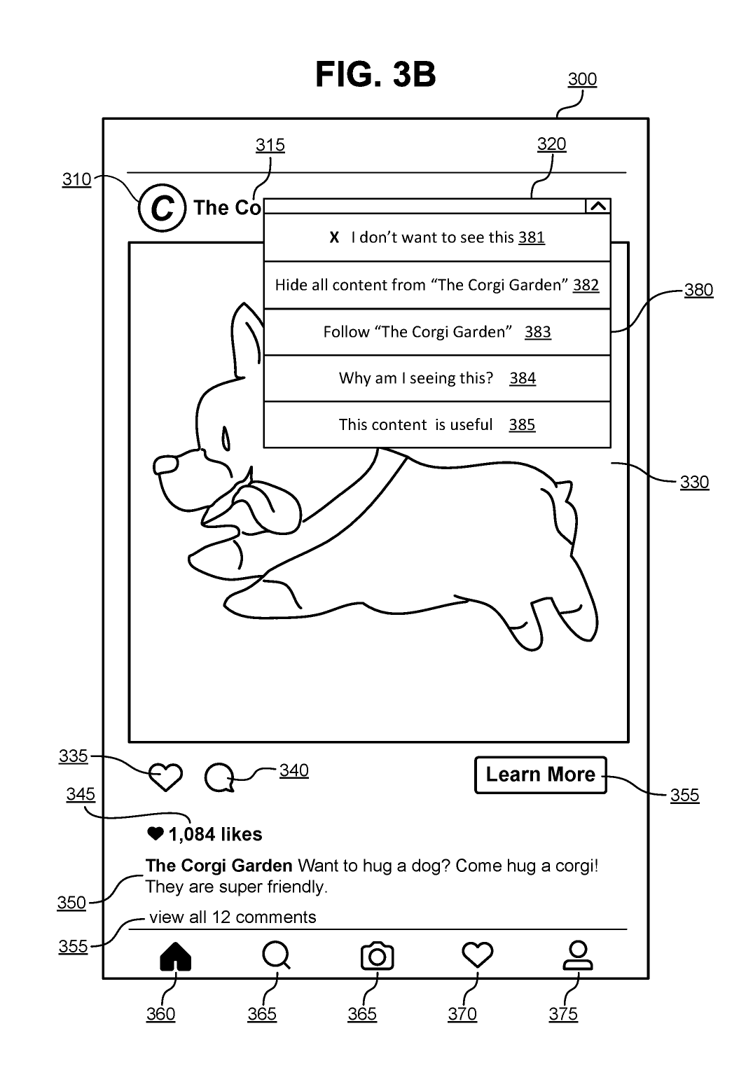

FIG. 3A and FIG. 3B illustrate examples of a user interface 300 for presenting content items to a user, according to an embodiment. The web server 290 of the online system 140 serves data, such as a web page, to a client device 110 which allows the client device 110 to display the user interface 300. The web server 290 may serve different user interfaces to different client devices 110 responsive to the type of client device 110 requesting the data. For example, a mobile device accessing the online system 140 via a dedicated software application, a mobile device accessing the online system 140 via a web browser, and a personal computer accessing the online system 140 via a web browser might each be presented with a different user interface. The type of content presented on each type of device may be different, as well. For example, some content may only be presented to mobile devices and other content may be presented to all devices.

The user interface 300 may include a newsfeed, which contains user-generated content accessed from the content store 220, such as a user post. The user post may be a content item created or uploaded by another user who the user viewing the user interface 300 is connected to on the online system 140 (e.g., a “friend” of the user). The user post may be, for example, a status, a digital image, a gallery of digital images, or a text post. The user interface 300 may provide means for interacting with and providing feedback to the user post.

The user interface 300 may also contain non-sponsored content and sponsored content such as the sponsored post 320. According to one embodiment, the post 320 contains a content provider title 315, a content provider image 310, sponsored content subtext 350, and an image 330. The content provider title 315, the content provider image 310, the sponsored content subtext 350, and the image 330 are examples of content which is stored in the content store 220.

Responsive to the user clicking on elements of the sponsored post 320, the user can be routed to a resource indicated by a network address that is part of the content of the sponsored post 320. The resource can be a web page or a page on the online system 140. Such an interaction is denoted herein as a “click.” Other analogous types of user interaction are also considered a “click” even if the interaction does not involve a mouse click (e.g., a user tapping on a touch screen).

The sponsored post 320 also contains user interface elements for a user to interact with the content without proceeding to the resource linked to the content. These interactions may increase or decrease the user's engagement with the content, such as by publically associating the viewing user with the page or by indicating that the content is not of interest to the user. For example, such user interface elements may include a “like page” button. Pressing the “like page” button is referred to as “liking” the page (e.g., a page on the online system 140) and an instance of a user interacting with this button is referred to as a “like.” The page of the online system 140 which is “liked” may be the page which is indicated by the network address of the content. Other means of “liking” a content item can include interacting with a similar “like” button on a social network page associated with the content provider or a web page outside of the online system 140. Such interactions may also contribute to the like bid for the content provider.

When the sponsored post 320 is presented to a user, the sponsored post 320 can indicate that other users of the online system 140 have “liked” the content. In some embodiments, a sponsored post 320 includes a button 335 for “liking” the content itself, in addition to or as an alternative to a link to the page associated with the content provider. In addition to the “like” button 335, another user interaction with the sponsored post 320 may be commenting on the content via a comment button 340.

The content of the sponsored post 320 also contains a dropdown menu button 325 which allows the user to provide additional feedback about the sponsored post 320. Clicking on or tapping the dropdown menu button 325 opens up the dropdown menu 380, as shown in FIG. 3B. In this embodiment, the dropdown menu 380 contains five buttons. In the example shown in FIG. 3B, the buttons are labeled “I don't want to see this” 381, “Hide all ads from ‘The Corgi Garden’” 382, “Follow ‘The Corgi Garden’” 383, “Why am I seeing this?” 384, and “This content is useful” 385. Clicking on or tapping these buttons may affect which content is presented to the user in future impressions. These buttons in the dropdown menu 230 provide additional user interaction with the sponsored post 320. Clicking or tapping on the “I don't want to see this” 381 and the “Hide all ads from ‘The Corgi Garden’” 381 buttons may be considered negative feedback, which may increase the value of negative feedback bids associated with the content from the same content provider. On the other hand, the “Follow ‘The Corgi Garden’” 383 and “This content is useful” 385 buttons can be considered positive feedback, which may increase the value of like bids associated with the content from the same content provider.

After content such as the sponsored content post 320 is presented to a user, the online system 140 may store the user's interaction with each content item as a user interaction in the content interaction store 250 in association with a user profile of the user and the content item. The stored user interaction may include user interaction parameters indicative of the user's interaction with the content item and feedback provided by the user about the content item. The user interaction may include some combination of user interaction parameters for a “click,” a “like,” a press of a button on the dropdown menu 380, or other signals. The user interaction may further include information indicating how the content was displayed to the user (e.g., whether it was displayed on a mobile device).

### Auction Module and Auction Process

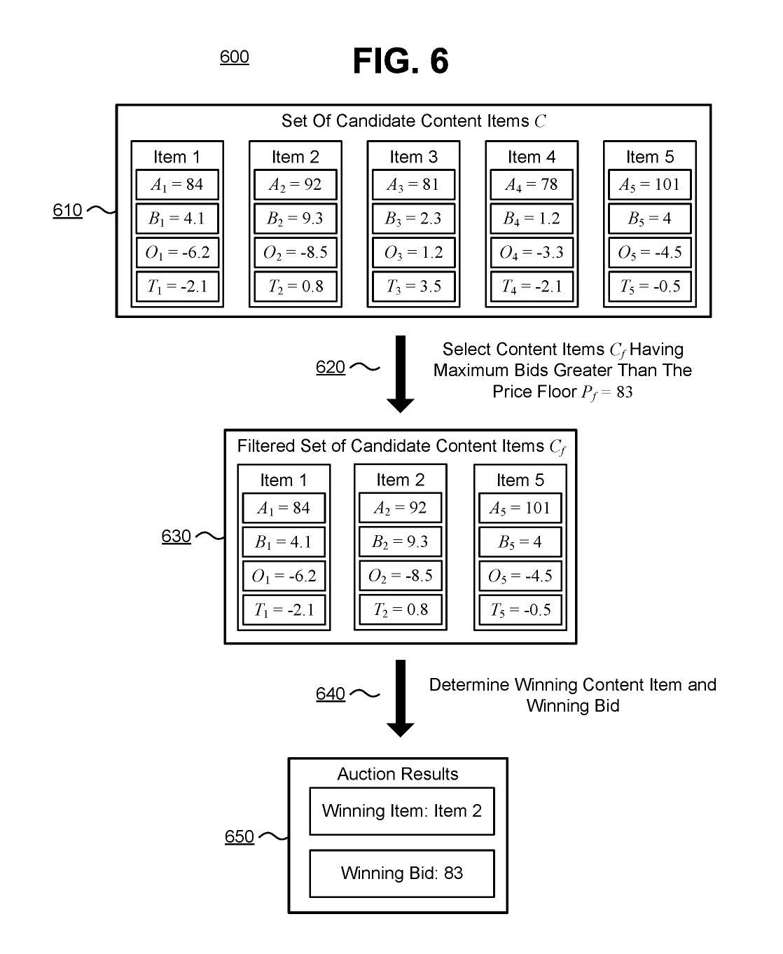

The auction module 260 receives a set of candidate content items for a target user from their corresponding content providers. For simplicity of description, a set of candidate content items is presented by a parameter, C. An example set of candidate content items 610, C, is shown in FIG. 6. Each of the candidate content items shown in FIG. 6 has four associated values, A, B, O, and T.

Aₙ represents the content provider bid value for an nth content item in the set of candidate content items 610. The content provider bid value is the maximum amount the content provider 130 is willing to pay to the online system 140 in exchange for presenting the content item to the user. For example, for content item, Item 1, its content provider is willing to pay at most 84 dollars.

Bₙ represents a system modified content provider bid associated with the nth content item in the set of candidate content items 610. In some embodiments, the system modified content provider bid is calculated using the content provider bid, a probability of achieving a conversion objective, Pr(Objₙ) by the nth content item, and a pacing multiplier, pₙ. The probability of achieving a conversion objective is a probability that the user who receives a content item will complete the conversion objective that was specified by the content provider 130 for the content item, such as adding the content item into a shopping cart or purchasing the content item. In one embodiment, the online system 140 trains a machine learning model for each user and uses the model to predict the probability of achieving a conversion objective by the user. The pacing multiplier is a value between zero and one that may be used by the online system 140 to help a content provider to spread a budget of the content provider over a period of time. That is, the auction module 260 can alter the pacing multiplier to adjust the system modified content provider bid value. By doing so, the auction module 260 can ensure that the budget of the content provider is not exhausted all at once. For example, the auction module 260 might set a pacing multiplier associated with a content provider low at the beginning of the day and adjust it upward in the afternoon so that the content provided by the content provider will win auctions in the afternoon when the target users of the content provider are most active, instead of spending the budget winning auctions in the morning. In one embodiment, the system modified content provider bid Bₙ is represented by Equation (1) below:

Bₙ=Pr(Objₙ)*pₙ*Aₙ (1)

Oₙ represents the value of the organic bid associated with the content item. In one embodiment, the organic bid is the difference between an estimated like bid, Lₙ, and an estimated negative feedback bid, Nₙ, which can be expressed as Oₙ=Lₙ−Nₙ. A like bid for a content item is a value, determined by the online system 140, that is based on a probability that a user will like the content item. A negative feedback bid for the content item is a value, determined by the online system 140, that is based on a probability that a user will give negative feedback for the content item. Organic bids may be positive or negative.

Tₙ represents the total bid associated with the nth content item in a set of candidate content items 610. A total bid value for the nth candidate in an auction, Tₙ, is the sum of a system altered content provider bid, Bₙ, and an organic bid, Oₙ, and can be expressed by Equation (2) below:

Tₙ=Bₙ+Oₙ. (2)

The auction module 260 receives a threshold value P_{f} associated with the target user. The threshold value is determined by the price floor module 280. The threshold value represents a minimum bid that a content provider needs to make to participate in the auction. The process of determining a threshold value will be discussed in more detail with respect to FIG. 5.

The auction module 260 selects a subset of the candidate content items C_{f} from the set of candidate content items C. In one embodiment, the selected subset of candidate content items is the subset of candidates that are associated with content provider bid values that are greater than the threshold value P_{f}. An example is shown in FIG. 6 in which the example price floor value is P_{f}=83, and the set of candidate content items 610 contains 5 content items. The content provider bids for each of the candidate content items in the set are: A₁=84, A₂=92, A₃=81, A₄=78, and A₅=101. The auction module uses the threshold value P_{f} to select a set of content items with content provider bids that are greater than P_{f} In other words, the selected set of content items are filtered by the threshold value P_{f}, and the filtered set of content items 630 contains Item 1, Item 2, and Item 5, because their content provider bids (A₁=84, A₂=92, and A₅=101) are all greater than the value of P_{f}, 83.

The auction module 260 determines a winning candidate content item and a winning bid from the selected candidate content items C_{f}. The winning candidate content item is the content item from the subset of content items C_{f} with the greatest total bid value, Tₙ. The winning bid is the value the online system 140 charges the content provider 130 associated with the winning candidate for presenting the content item to the user whenever the user completes a conversion. In one embodiment, the winning bid value is the larger value of either the difference between the second highest total bid (i.e., the total bid of a second place candidate content item) and the organic bid of the winning content item divided by the predicted probability of conversion for the winning content item or the threshold value P_{f} That is, the winning bid for the set of candidate content items is described by Equation (3) below:

W_{C}=max{(T_{second}−O_{win}/Pr(Ob_{win}),P_{f}} (3)

where W_{C} represents the winning bid for the set of candidate content items, T_{second} represents the bid of the second highest total bid among the bids for the set of candidate content items, O_{win} represents the organic bid of the winning content item, and Pr(Ob_{win}) represents the probability of the conversion of the winning content item.

Applying Equation (3) to the example in FIG. 6, the auction module 260 determines the winning content item and the winning bid among the filtered set of candidate content items, C_{f}. The auction results 650 show that the winning candidate content item is Item 2 because it has the largest total bid value of T₁=−2.1, T₂=0.8, and T₅=−0.5. The winning bid is 83, the value of the example threshold value P_{f} The example winning bid calculation can be shown as:

Winning Bid=max((−0.5−(−8.5))/0.1,83)=max(80,83)=83

Where the probability of achieving the conversion objective, Pr(Obj₂) of Item 2, is 0.1 for the sake of the example. So, the content provider 130 associated with Item 2 will pay the online system 140 $83 to present Item 2 to the target user.

FIG. 4 is a flowchart illustrating a process 400 of performing an auction by the auction module 260 of the online system 140, according to an embodiment. The process 400 selects a content item from a set of candidate content items to present to a target user. The selection is based on bid values submitted by content providers for each candidate content item. The steps illustrated in FIG. 4 may be executed in an order different from that indicated in FIG. 4. Furthermore, the steps may be executed by modules different from the modules indicated herein.

The auction module 260 receives 410 a request from the online system 140 to present content to a target user or target audience that includes the target user among other users. The request comes from a third party system such as a user/administrator of the content provider system 130. A request includes a content item, and a content provider bid value (though as explained above, in some cases the content provider only provides budget information and the online system determines the bid value). A request may additionally include information about a conversion objective, target user types, and instructions about when a bid for the content item should be entered into an auction. A conversion objective indicates the type of conversion the content provider 130 wants the online system 140 to monitor with respect to the content item. Examples of conversion objectives include user actions taken in response to receiving a content item, such as clicking on the content item, watching a video contained in the content item, or purchasing a product that is advertised in the content item. Received requests are stored by the online system 140 in the content store 220.

The auction module 260 access 420 a set of candidate content items from one or more content providers, each candidate content item having a content provider bid value. The auction module also accesses 430 a price floor value, P_{f}, determined by the price floor module 280 of the online system 140, for the target user. The auction module 260 selects 440 a subset of the candidate content items using the determined price floor value, where each selected candidate content item has a provider bid value greater than the price floor value. The auction module 260 determines 450 the winning candidate content item based on the total bid value associated with each selected candidate content item (e.g., using Equation (2)) and the winning bid value using Equation (3). The auction module 260 provides 460 the winning content item to the target user and charges the content provider of the winning content item the winning bid value.

### Price Floor Module and Process for Threshold Value Determination

Returning back to FIG. 2, the price floor module 280 determines a threshold value for a target user in an auction, where the determined target value is used by the auction module 260 to select a winning content item and to determine a winning bid value of the winning content item as described above. In one embodiment, the price floor module 280 determines the threshold value for a target user based on historical auction data associated with the target user. Records about previous auctions associated with the target user are stored in the auction record store 270. The price floor module 280 selects a subset of the candidate content items from the previous auctions based on the providers' bids of the candidate content items. In one embodiment, the price floor module 280 considers candidate content items from previous auctions within a predetermined number of days before the present. For example, the price floor module 280 may consider those auctions that occurred in the preceding 7, 14, or 30 days.

The price floor module 280 selects a predetermined number of candidate content items from each auction within the predetermined time period based on the corresponding providers' bid values of the candidate content items. For example, the price floor module 280 may select a top 5% of candidate content items with the highest provider bid values from each auction that occurred in the last 7 days for the target user.

The price floor module 280 determines a threshold value to be used as a price floor, P_{f}, in the auction for the user based on the total bid values of the selected candidate content items. The price floor module 280 orders the content provider bid values of the selected candidate content items. The content provider bid value that is at a predetermined percentile value of the ordered provider bid values is used as the threshold value. For example, if the predetermined percentile value is 70, then the threshold value is set as equal to the content provider bid from the selected subset of candidates for which 70 percent of the content provider bid values from the subset have a lesser bid value.

FIG. 5 is a flowchart illustrating a process 500 of determining a threshold bid value for a target user in an auction by the price floor module 280, according to an embodiment. The determination is based on the historical auctions associated with the target user. The steps illustrated in FIG. 5 may be executed in an order different from that indicated in FIG. 5. Furthermore, the steps may be executed by modules different from the modules indicated herein.

Initially, the price floor module 280 obtains 510 records of previous auctions associated with a target user, and selects 520 a predetermined number of candidate content items from each auction within a period of time, e.g., 5% of content items in each auction. The floor module 280 orders the selected content items according to their corresponding content provider bid values, and selects 530 a subset of content items based on a cutoff position in the ordered content provider bid values, e.g., at 70% position of the ordered content provider bid values. The price floor module 280 selects 540 the content provider bid value corresponding to the cutoff position as the price floor value for the target user.

Determining a user specific threshold value for a target user and using the determined threshold value for the target user in an auction encourages content providers to participate in auctions provided by the online system 140, while at the same time, enables the content providers to bid truthfully.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a set of candidate content items in requests from content providers to present content items to target audiences including target users, each of the candidate content items having information describing a plurality of bid values;
selecting a threshold value for a bid required for a candidate content item to enter an auction to be presented to a target user, the threshold value based on a plurality of historical auction data associated with the user;
selecting a subset of the candidate content items eligible to enter the auction based on the selected threshold value associated with the user, each selected candidate content item having a bid value for a corresponding content provider greater than the threshold value,
determining in the auction a winning candidate content item having a highest bid value of the selected candidate content items based on total bid values of the selected candidate content items;
determining a winning bid to charge for providing the winning candidate content item to the user, the winning bid based on a function of the threshold value associated with the user, an organic bid value of the winning candidate content item, and a total bid value of a second place candidate content item having a second highest bid value; and
providing the winning candidate content item associated with the determined winning bid to a client device for presentation to the user.

2. The method of claim 1, wherein selecting the threshold value for a bid required for a candidate content item to enter the auction to be presented to the target user comprises:
accessing records of a set of prior auctions associated with the target user, each prior auction having information describing candidate content items that participated in the prior auction, each candidate content item having a content provider bid value;
for each content item from each prior auction, selecting a predetermined number of the candidate content items of the prior auction; and
determining the threshold value based on a percentile of the ordered provider bid values of the selected subsets of recorded candidate content items.

3. The method of claim 1, wherein the total bid value of each candidate content item is a summation of the organic bid of the candidate content item and a system modified content provider bid.

4. The method of claim 3, wherein the system modified content provider bid of a candidate content item is determined based on a maximum bid value of the candidate content item offered by a content provider providing the candidate content item and an estimated rate of performing a bid objective of the candidate content item.

5. The method of claim 3, wherein the organic bid of a candidate content item is determined based on an estimation of a likelihood of the candidate content item receiving positive feedback from the target user and an estimation of a likelihood of the candidate content item receiving negative feedback from the target user.

6. The method of claim 1, wherein each of the subset of the candidate content items eligible to enter the auction, selected based on the selected threshold value associated with the target user, have a content provider bid greater than or equal to the threshold value.

7. The method of claim 1, wherein the winning candidate content item is the content item with the greatest total bid value among the set of selected candidate content items.

8. The method of claim 1, wherein a second place candidate content item from the selected candidate content items is the candidate content item having a second largest total bid among the set of selected candidate content items.

9. The method of claim 1, wherein determining a winning bid to charge for providing the winning candidate content item to the user, the winning bid based on a function of the threshold value associated with the user, an organic bid of the winning candidate content item and, a total bid value of the second place candidate content item comprises:
selecting a greater value of the threshold value or a difference between the total bid value of the second place candidate content item minus the organic bid of the winning candidate content item divided by a probability of the winning candidate content item being converted by the target user.

10. The method of claim 1, wherein selecting a threshold value for a bid required for a candidate content item to enter the auction to be presented to the target user comprises:
selecting historical auction data associated with the user that occurred during a predetermined period of time.

11. A non-transitory computer-readable storage medium comprising instructions which, when executed by a processor, cause the processor to perform the steps of:
receiving a set of candidate content items in requests from content providers to present content items to a target audiences including target users, each of the candidate content items having information describing a plurality of bid values;
selecting a threshold value for a bid required for a candidate content item to enter an auction to be presented to a target user, the threshold value based on a plurality of historical auction data associated with the user;
selecting a subset of the candidate content items eligible to enter the auction based on the selected threshold value associated with the user, each selected candidate content item having a bid value for a corresponding content provider greater than the threshold value,
determining in the auction a winning candidate content item having a highest bid value of the selected candidate content items based on total bid values of the selected candidate content items;
determining a winning bid to charge for providing the winning candidate content item to the user, the winning bid based on a function of the threshold value associated with the user, an organic bid value of the winning candidate content item, and a total bid value of a second place candidate content item having a second highest bid value; and
providing the winning candidate content item associated with the determined winning bid to a client device for presentation to the user.

12. The non-transitory computer-readable storage medium of claim 11, wherein selecting the threshold value for a bid required for a candidate content item to enter the auction to be presented to the target user comprises:
accessing records of a set of prior auctions associated with the target user, each prior auction having information describing candidate content items that participated in the prior auction, each candidate content item having a content provider bid value;
for each content item from each prior auction, selecting a predetermined number of the candidate content items of the prior auction; and
determining the threshold value based on a percentile of the ordered provider bid values of the selected subsets of recorded candidate content items.

13. The non-transitory computer-readable storage medium of claim 11, wherein the total bid value of each candidate content item is a summation of the organic bid of the candidate content item and a system modified content provider bid.

14. The non-transitory computer-readable storage medium of claim 13, wherein the system modified content provider bid of a candidate content item is determined based on a maximum bid value of the candidate content item offered by a content provider providing the candidate content item and an estimated rate of performing a bid objective of the candidate content item.

15. The non-transitory computer-readable storage medium of claim 13, wherein the organic bid of a candidate content item is determined based on an estimation of a likelihood of the candidate content item receiving positive feedback from the target user and an estimation of a likelihood of the candidate content item receiving negative feedback from the target user.

16. The non-transitory computer-readable storage medium of claim 11, wherein each of the subset of the candidate content items eligible to enter the auction, selected based on the selected threshold value associated with the target user, have a content provider bid greater than or equal to the threshold value.

17. The non-transitory computer-readable storage medium of claim 11, wherein the winning candidate content item is the content item with the greatest total bid value among the set of selected candidate content items.

18. The non-transitory computer-readable storage medium of claim 11, wherein a second place candidate content item from the selected candidate content items is the candidate content item having a second largest total bid among the set of selected candidate content items.

19. The non-transitory computer-readable storage medium of claim 11, wherein determining a winning bid to charge for providing the winning candidate content item to the user, the winning bid based on a function of the threshold value associated with the user, an organic bid of the winning candidate content item and a total bid value of the second place candidate content item comprises:
selecting a greater value of the threshold value or a difference between the total bid value of the second place candidate content item minus the organic bid of the winning candidate content item divided by a probability of the winning candidate content item being converted by the target user.

20. The non-transitory computer-readable storage medium of claim 11, wherein selecting a threshold value for a bid required for a candidate content item to enter the auction to be presented to the target user comprises:
selecting historical auction data associated with the user that occurred during a predetermined period of time.
